(19) United States
(12) Patent Application Publication
(10) Pub. No.: US 2018/0063312 A1
(43) Pub. Date: Mar. 1, 2018

(54) Touch screen device embedded on fashion item as complementary display screen for smartphone

(71) Applicant: Chiou-muh Jong, Ellicott City, MD (US)

(72) Inventor: Chiou-muh Jong, Ellicott City, MD (US)

(21) Appl. No.: 15/497,133

(22) Filed: Apr. 25, 2017

Related U.S. Application Data
(60) Provisional application No. 62/380,436, filed on Aug. 28, 2016.

(51) Int. Cl. H04M 1/725; A45C 3/02

(52) U.S. Cl. CPC H04M 1/7253; A45C 2011/003; A45C 3/02

(57) ABSTRACT

The present invention is about a smartphone system with two touch screen displays. Fashion items such as handbags, backpacks, toolboxes and jackets etc., which are carried or worn in daily life by most women, students and professionals, usually have a flat surface area much bigger than the screen of a typical smartphone. Such flat surface on daily used item is ideal for installing a touch screen device for alternatively displaying heavy content, which is difficult to be seen clearly on a small screen of a typical smartphone. The display device works as a master in slaving the smartphone for most of its functions which need bigger display screen. Such display devices can be much cheaply built as compared to conventional tablets and can be attached permanently or temporarily to handbags or backpacks and the likes.

### CROSS-REFERENCES TO RELATED APPLICATIONS

This non-provisional utility application was filed within one year of and claims a domestic priority date of Aug. 28, 2016 based on U.S. provisional application No. 62/380,436, filed Aug. 28, 2016.

### DESCRIPTION

### 1. Field of the Invention

This invention related to touch screen devices, smartphones in particular. It also related to using a flat surface of a daily carrying item to install a much bigger touch screen for displaying smartphone page content.

### 2. Background of the Invention

In the history of telephone developments, smartphone has been the fastest spreading phone system to be accepted by most people in the whole world. Year after year, new smartphones from brand names such as Apple Inc., Samsung Electronics and Google etc. are pushing out new design to their phone systems with newly added functions to compete on the whole international market.

However, smartphone is a hand-held device, which means that the display area for any smartphone is severely limited by the size of human hands and consequently the display screens on smartphones have difficulty to display content-rich pages on the typically palm size display area. For this reason, smartphone manufacturers have increased the sizes of the smartphone to bigger sizes in recent years. Apple's iPhone for example, has increased from 124×59 mm of screen size for model 5S to 138×67 mm for model 6S and even bigger 158×78 mm for model 6S Plus. The increased sizes do make the display of smartphone easier for our eyes; they are still too small nevertheless as compared to the screens of tablet computers.

Due to the small display screen of smartphones, regardless of brand names, tablet computers get a niche market to be used for a lot of display functions exist in the smartphones. However, an independent tablet computer need additional data plan to support its wireless internet connection, which costs additional monthly charge for the user. In addition, tablet computer has a lot of hardware components shared with smartphones, which is a waste if a user owns simultaneously a tablet computer and a smartphone.

For the reason mentioned above, U.S. Patent application 2013/0109374 by Kwon proposed a solution to use smartphone processing power for processing a bigger size touch screen device as a way to eliminate the requirement of using different data plan for the bigger display screen and at the same time lower the cost of tablet computer or makes fully equipped tablet computer unnecessary.

Kwon's solution does solve the small display screen problem for the smartphones. However, smartphones are invented to be small and handy to use. If we are required to bring another bigger screen to go with the smartphone, it is then meaningless to make smartphones small and handy in the first place.

PCT patent application WO 2015067289 by Boris suggests a way to connect smartphone and a tablet to take advantages of bigger screen. By providing a slot in the tablet for inserting smartphone, smartphone and tablet devices are physically connected without using any short distance communication module. While this is yet another easy way to display smartphone page content in a bigger screen, it is not a good solution for the same reason as described in above paragraph.

U.S. patent application 20060061546 by Jong disclosed a good way to use the flat surface of a daily carrying item such as a handbag to embed a display device for a personal computer and take advantages of the big volume to install some hardware such as battery and charging device. This is a good idea because most women carry handbags with them in a big portion of their daily life or activities outside their home, all students carry backpacks with big flat surface on them and a lot of men carrying briefcases which have big surface too. All together, we can see that almost 80% of potential smart phone users carry fashion items when they are out of their home with their smartphones. The flat surfaces on such daily carrying items thus are ideal for installing touch screen devices with display area substantially bigger than the screen of the typical smartphones.

By taking advantages of flat surface of a fashion item, it is always with the user who carries it and never forgets to bring the display device wherever the user goes.

### 3. BRIEF SUMMARY OF THE INVENTION

A way to significantly increase the display screen of a smartphone which is useful for nearly eighty percent of potential smartphone users is invented. By installing a master touch screen display device on the flat surface of a daily carrying fashion item, the smartphone user can operate the master touch screen as an alternative smartphone whenever the smartphone is within the distance of communication wirelessly.

It is therefore a primary objective to take advantages of the flat surface of an item carried by about eighty percent of smartphone users to display content-rich information on the bigger screen for easy viewing.

Another objective is to maintain the palm size as the standard size of smartphones for easy and handy operation without the concern of too small display screen.

Yet another objective of this invention is for smartphone manufacturers to solve the small screen problem of smartphones with very affordable cost.

Still another objective is to increase the revenue for smartphone manufacturers by adding a fashion item with display screen as another product line.

One more objective is to eliminate the need of a tablet computer for displaying substantial portion of content available on a smartphone.

Yet one more objective is to add competitiveness for the smartphone manufactures who manufacture the fashion items to match their smartphones.

Still one more objective of current invention is to give warning to the easy-to-forget students do not forget their smartphones if they are not within the communication distance.

A final objective of current invention is to make wearing electronic items such as smartwatches much more useful by pairing it to a master touch screen device.

### 4. BRIEF DESCRIPTION OF THE DRAWINGS

FIG. 1 shows a typical backpack carried to school by most students. A touch screen display device is installed on the surface of the backpack for use as alternative smartphone for bigger display area. Also shown in FIG. 1 is the smartphone to pair with the display device on the backpack. Notice that the smartphone and the display device have the same form factor, or aspect ratio, but this is not a necessary requirement.

Also shown in the FIGURE is that both display devices have similar layout of same image icons used as command icons. Such arrangement is intended for less confusion when switching uses between smartphone and the touch screen display device used as master device to slave smartphone for correct page of content for display.

### 5. DETAILED DESCRIPTION OF THE INVENTION

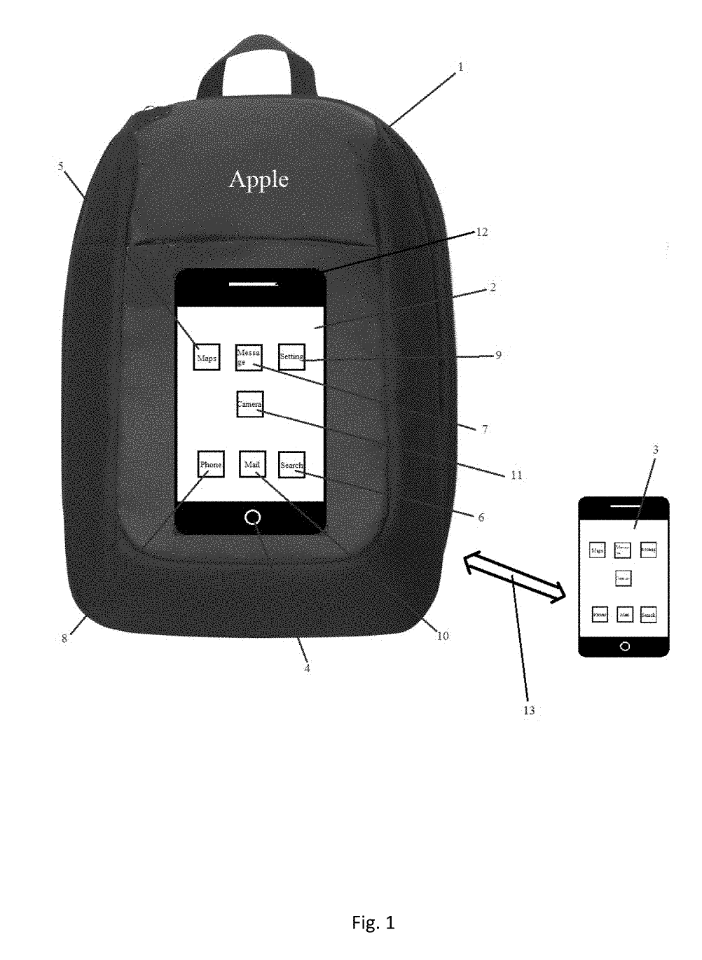

Illustrated in FIG. 1 is the preferred embodiment of current invention, wherein a backpack with a touch screen device used as master touch screen device is installed, permanently or semi-permanently. Item 1 in the FIGURE is a typical backpack with plenty flat surfaces on front and back sides for installing item 2, which is the touch screen display device to be used as an alternative smartphone.

Item 3 shows the smartphone to be paired with touch screen display device 2. Item 4 shows the Home button typically used to start the phone operation. Item 5, 6, 7, 8, 9, 10 and 11 are example command icons of one of several pages exist on the smartphone 3 and they are used for showing maps, web search, sending messages, phone calling, parameter setting, emailing and operating camera respectively. These example command icons are typically arranged in the first or home page of the smartphones. There are many other command icons obtaining from downloading applications and can be arranged in second or page depends on the number of command icons.

Item 12 shows the speaker of the smartphone. The double arrow 13 is used to illustrate a short distance communication module which uses IEEE standards 802.11 or Bluetooth to link between the smartphone and the master touch screen display device. When the smartphone 3 is out of the short communication distance, which may range from 2 meters to 10 meters depends on the module; it will be an independent device working just like another smartphone of the same model with no pairing architecture.

Like its counterpart Home button on the item 3, item 4 is used to start the master touch screen device. When it is touched, the finger print or pass code will be sent to smartphone for the authorization of login.

Not all functions exist in smartphone are suitable to be operated on the master touch screen display device. The Camera command icon, for example, includes the action to take pictures or videos and it will be awkward to hold the whole backpack as a camera for taking videos or pictures. However, sub-functions inside the Camera command icon also include functions to display the videos and pictures and hence should be ideal to be operated in master touch screen device. Therefore it is up to manufacturer's decision to install camera hardware to the master touch screen device or not. In addition, it is only possible to install front side camera while both front and back cameras exist in most new models of smartphones used today. So the Camera command icon will be considered as partially working command icon which does not have all the functions available in smartphone.

If the master touch screen device does not include a camera hardware to physically take the pictures or videos, then when the Camera command icon on the master touch screen device is touched, the screen will show the most recent picture or video instead of the dynamic view the camera is facing—which is the default display when the Camera icon is touched in a typical smartphone. However, all the sub command icons associated with the page when picture or video is displayed, such as Delete (for deleting photos) and Select (Go to selection page to select photo to email or message to other users) will be all available on the master touch screen device for the user to operate. In other words, any function not suitable, awkward or impossible functions can be omitted in the master touch screen.

When the user touches the master touch screen, the position he/she touches on the screen can be displaying a link or a command icon. If it is a link, the master touch screen device will send the link address through the short distance communication module back to the real smartphone it is pairing with, and the running smartphone, which is synchronously running and having the current page in its memory, will decode the link address and send the content through short distance communication module for display on the master touch screen. A smartphone can be modified in the manufacturing stage so that it will be able to automatically turn off the display to save battery power when it is used in slaved mode.

If, on the other hand, the user touches a command icon, then the master touch screen device will send the normalized coordinate (x, y), where 0<x<1 and 0<y<1 back to the slaved smartphone to determine which command icon is touched. The slaved smartphone in turn sends back the content just like the user touches the command icon on its own screen to the master touch screen. If both of master touch screen and smartphone screen have the same form factor or aspect ratio, all the command icon pairs (and sub command icon pairs) will be on the same location in terms of normalized coordinates and it is trivial for the slaved smartphone to know which command icon is touched by the user on the master touch screen. If the form factors are different for the two screens, the physical locations of the command icons on the two screens will look different because they are of different shape, but the normalized coordinates will be the same for both screens unless one of the two screens is not rectangular.

While it is easy to see the benefits of current invention when implemented to smartphones, it is even more beneficial when it applied to wearing smart electronic such as smartwatches because of their relatively small display areas. In other words, the current invention, when implemented to pair a smartwatch with a master touch screen device, the much bigger display on the master touch screen make the smartwatch much more useful. For years, wearing electronics items are more difficult to design as compared to the typical smartphones because of very limited display area. The smartwatches usually have a form factor different than that of smartphones from same manufacturer, but it poses no difficulty to be implemented as long as the master touch screen device it pairs and the screen of smartwatches have rectangular shape.

Smartphone manufacturing is a very competitive business, and frequently at least one killer feature is needed to make it stands out. Any manufacturer who takes the advantages of current invention will be greatly benefited by adding product line of fashion items to match its smartphone models and consequently gaining more revenue from additional product lines. To make the fashion item embedded with master touch screen look attractive, manufacturers should team up with fashion designers or hire them to come up with good looking design so to attract smartphone users.

The embodiment of current invention to other daily carrying fashion items such as handbags for women and some men, briefcases for a big portion of men who go to offices or work as contractors doing their own business, and even the lunch bags with insulation can be easily implemented as the backpack example described in FIG. 1. However, backpack implementation which gives warning when the smartphone is out of short distance communication range will be an especially useful feature for most students because they are the group of smartphone users who tend to forget bringing their smartphones.

Some daily carrying items such as backpacks and briefcases have volume big enough to add hardware inside without affecting their original usage. In such case, the fashion designers and engineers may work together to design the items to include batteries big enough to charge the smartphones inside and master touch screen devices by wire connection or wireless and the batteries for the items by wire connection or wireless. Wireless charge for smartphone inside the fashion item and fashion item itself is a very convenient feature for the users and the users are definitely happy to have such feature available which can promote the sales of smartphones easily.

It is preferable to design the master touch screen device 2 look similar to the smartphone it pairs with. And it is also preferable to have the command icons on the master touch screen look exactly like their counterparts on the smartphone 3 and have same layouts as shown in FIG. 1 such that the users will be intuitively easy to operate both machines.

For simplicity, backpack 1 did not show a cover for covering the screen when it is not used. However, to protect the master touch screen device, it is also preferable to design a good looking cover for the screen. In addition, a protective board of light and strong material such as aluminum is needed to support the installation of master touch screen device such that it is relatively secure to last. A flexible touch screen can also be used when it is available on the market.

For any manufacturer, investment to add a product line by implementing current invention is very little because they already have all the technologies and software to put a master touch screen device on the daily carrying fashion item to communicate with the existing smartphone models. It is a small investment with potentially big harvest.

The embodiments presented above are typical implementations of current invention. Various modifications can be made without departing from the scope of current invention, which is defined in the attached claims. For example, the daily carrying fashion item can be a piece of cloth, a jacket or a pair of pant. Any modification based on such item is apparent to those who are skilled in the art upon reference to the description above. It is therefore intended that the attached claims cover any such modification or embodiment.

I claim:

1. A complementary dual touch screen smartphone system comprising:
a smartphone with a phone touch screen,
a master touch screen device comprising an input and output audio device and a touch screen significantly larger in display area than said phone touch screen and preferably with same aspect ratio as said phone touch screen,
a short range communication module linking between said smartphone and said master touch screen device,
a counter command icon on said master touch screen device for every command icon on each page of said phone touch screen to form command icon pairs for all functions intended to be operable on said master touch screen device and
an one to one corresponding communication scheme between each member of said command icon pair, wherein a master-slave relationship is maintained for commanding the functions of said smartphone by touching command icons on said master touch screen device,
whereby the master touch screen device in the complementary dual touch screen smartphone system can be operated as a large screen smartphone by touching each command icon on the screen, thereby slaving said smartphone through said short range module by activating paired counter command icon on phone touch screen exactly the same effect as touching said paired counter command icon directly by the user to output visual and audio content on said master touch screen device.

2. The smartphone according claim 1 is fully functional and can be operated independently like a traditional smartphone without pairing to said touch screen display device.

3. The master touch screen device according to claim 1 further comprising a software module to import current version of command icons from said fully functional smartphone and rebuild master-slave relationship every time said smartphone gets software updated.

4. A method for pairing a touch screen display device to a smartphone device comprising the steps of:
providing a smartphone with a phone touch screen,
providing a master touch screen device comprising an input and output audio device and a touch screen significantly larger in display area than said phone touch screen and preferably with same aspect ratio as said phone touch screen,
loading a short range communication module for linking said smartphone and said master touch screen device,
loading a counter command icon for every function in smartphone intended to be operated in said master touch screen device to form command icon pairs,
updating command icons in said master touch screen device through said short range communication module every time any command icon on said smartphone device is updated and
building a master-slave relationship for every pair of the command icon pairs therefrom touching a command icon on said master touch screen device resulting in the same effect as touching its counterpart command icon on said smartphone;
whereby the pairing of a touch screen display device to a smartphone device will enable the usage of the master touch screen device as a smartphone with larger display area by slaving the pairing smartphone running synchronously to provide visual and audio content to the master touch screen device.

5. The smartphone according claim 4 is fully functional and can be operated independently like a traditional smartphone without pairing to said touch screen display device.

6. The master touch screen device according to claim 4 further comprising a software module to import current version of command icons from said fully functional smartphone and rebuild master-slave relationship every time said smartphone gets software updated.

7. A method for increasing a smartphone display area comprising the steps of:
providing a smartphone with a phone touch screen,
providing a master touch screen device attached to the flat surface of a daily carrying fashion item, the master touch screen device comprising an input and output audio device and a touch screen significantly larger in display area than said phone touch screen and preferably with same aspect ratio as said phone touch screen,
loading a short range communication module for linking said smartphone and said master touch screen device,
loading a counter command icon for every function in smartphone intended to be operated in said master touch screen device to form command icon pairs,
updating command icons in said master touch screen device through said short range communication module every time any command icon on said smartphone device is updated and
building a master-slave relationship for every pair of the command icon pairs therefrom touching a command icon on said master touch screen device resulting in the same effect as touching its counterpart command icon on said smartphone device;
whereby the master touch screen device attached to the flat surface of a daily carrying fashion item with substantially bigger display area can be operated as an alternative smartphone with bigger touch screen by slaving said smartphone device in running synchronously to provide visual and audio content to the master touch screen device.

8. The smartphone according claim 7 is fully functional and can be operated independently like a traditional smartphone without pairing to said touch screen display device.

9. The master touch screen device according to claim 7 further comprising a software module to import current version of command icons from said fully functional smartphone and rebuild master-slave relationship every time said smartphone gets software updated.

10. A method for deriving more value from a smartphone device comprising the steps of:
providing a smartphone with a phone touch screen,
providing a daily carrying fashion item with a flat surface substantially bigger in area than the area of said phone touch screen,
attaching permanently or semi-permanently a master touch screen device comprising an input and output audio device and a touch screen substantially larger in display area than said phone touch screen and preferably with same aspect ratio as said phone touch screen on the flat surface of said daily carrying fashion item,
loading a short range communication module for linking said smartphone and said master touch screen device,
loading a counter command icon for every function in smartphone intended to be operated in said master touch screen device to form command icon pairs,
updating command icons in said master touch screen device through said short range communication module every time any command icon on said smartphone device is updated and
building a master-slave relationship for every pair of the command icon pairs therefrom touching a command icon on said master touch screen device resulting in the same effect as touching its counterpart command icon on said smartphone device;
whereby the daily carrying fashion item is derived as extra commercial value to said smartphone and the substantially bigger display area on said master touch screen device can be operated as an alternative smartphone with bigger touch screen by slaving said smartphone device in running synchronously to provide visual and audio content to the master touch screen device.
